(19) United States
(12) Patent Application Publication
(10) Pub. No.: US 2011/0318668 A1
(43) Pub. Date: Dec. 29, 2011

(54) MEMBRANE-ELECTRODE ASSEMBLY FOR FUEL CELL, FUEL CELL AND MANUFACTURING THE METHOD THEREOF

(75) Inventors: Eon Soo Lee, Gyeongsangbuk-do (KR); Yung Eun Sung, Gyunggi-do (KR); Min Jeh Ahn, Seoul (KR); Yong Hun Cho, Gyunggi-do (KR); Nam Gee Jung, Seoul (KR); Jae Hyuk Jang, Seoul (KR)

(73) Assignee: SAMSUNG ELECTRO-MECHANICS CO., LTD., Gyunggi-do (KR)

(21) Appl. No.: 13/073,460

(22) Filed: Mar. 28, 2011

(30) Foreign Application Priority Data
Jun. 29, 2010 (KR) 1020100061970

(51) Int. Cl. H01M 8/04; H01M 8/00; B05D 5/12; H01M 8/10

(52) U.S. Cl. 429/481; 429/535

(57) ABSTRACT

Disclosed herein are a membrane-electrode assembly for a fuel cell, a fuel cell, and a manufacturing method thereof. The present invention forms a micro current collecting layer between a gas diffusion layer and a micro porous layer and surface-contacts a pair of laminates for an electrode so that each electrolyte layer formed by applying an electrolyte solution thereon contacts with each other, thereby shortening a moving distance of electrons to minimize the current collecting resistance and loss and reduce the interface resistance.

### CROSS REFERENCE TO RELATED APPLICATION

This application claims the benefit of Korean Patent Application No. 10-2010-0061970, filed on Jun. 29, 2010, entitled “Membrane-Electrode Assembly For Fuel Cell, Fuel Cell And Manufacturing Method Thereof”, which is hereby incorporated by reference in its entirety into this application.

### BACKGROUND OF THE INVENTION

1. Technical Field

The present invention relates to a membrane-electrode assembly for a fuel cell, a fuel cell, and a manufacturing method thereof.

2. Description of the Related Art

Researches on polymer electrolyte membrane (PEM) fuel cells as one type of fuel cell have been conducted in various aspects. In view of a structure, the PEM fuel cell has an electrolyte disposed on an intermediate surface thereof and electrodes, that is, a cathode and an anode, disposed on both surfaces thereof, such that it has polarity. In addition, materials used for the cathode and the anode should have conductivity and serve to discharge water, a reactant, while simultaneously supplying fuel gas and air. The cathode and anode material layers are generally called gas diffusion layers. In this case, in order to improve gas diffusion of the gas diffusion layers and discharge performance of the reacted water, micro porous layers are added between the electrolyte layer and the gas diffusion layers. As a result, the gas diffusion performance of gas and the discharge performance of the reactant may be improved.

In general, a unit cell is manufactured by separately manufacturing the gas diffusion layer and the electrolyte layer and then bonding them. In this case, the cell may be manufactured using two methods: coating the micro porous layer on the gas diffusion layer to manufacture the gas diffusion layer bonded with the micro porous layer and bond the electrolyte layer thereto; and coating the micro porous layer on the electrolyte layer to manufacture the electrolyte layer on which the micro porous layer is applied and bond the gas diffusion layer thereto.

However, when the gas diffusion layer and the electrolyte layer are each separately manufactured and bonded as described above, however, a high-temperature and high-pressure hot pressing process should be conducted in order to reduce interface resistance between the bonded layers and a contact status of each interface is deteriorated causing degradation in the performance. In addition, it costs a great deal to manufacture an electrolyte membrane generally used as an electrolyte layer and a pretreatment process of the electrolyte membrane is required, thereby being disadvantageous in expense and mass production.

### SUMMARY OF THE INVENTION

The present invention has been made in an effort to provide a membrane-electrode assembly for a fuel cell and a fuel cell in which contact surface resistance between the interfaces is minimized while each interface is closely in contact with each other.

Further, the present invention has been made in an effort to provide a membrane-electrode assembly for a fuel cell and a fuel cell capable of minimizing current collecting resistance and loss at the time of collecting current.

Further, the present invention has been made in an effort to provide a method for manufacturing a fuel cell through an integrated continuous process, not through a discrete process.

Further, the present invention has been made in an effort to provide a fuel cell directly connected to a unit cell without being subjected to a separate heat treating process.

A membrane-electrode assembly for a fuel cell according to a first preferred embodiment of the present invention includes: an electrolyte layer formed by surface-contacting two electrolyte solutions with each other; catalyst layers that are disposed on both surfaces of the electrolyte layer; micro porous layers that are disposed on both surfaces of the catalyst layer; micro current collecting layers that are disposed on both surfaces of the micro porous layer; and gas diffusion layers that are disposed on the both surfaces of the micro current collecting layers.

Preferably, the micro current collecting layers may be made of Au, Ag, Cu, Al, Fe, an alloy thereof, or a combination thereof.

Preferably, the micro current collecting layer has a mesh structure.

Preferably, the micro current collecting layer may be set to have a thickness of several μm to several tens of μm.

Preferably, the micro current collecting layer is impregnated in the micro porous layer.

A fuel cell according to a second preferred embodiment of the present invention includes: an electrolyte layer formed by surface-contacting two electrolyte solutions with each other; catalyst layers that are disposed on both surfaces of the electrolyte layer; micro porous layers that are disposed on both surfaces of the catalyst layer; micro current collecting layers that are disposed on both surfaces of the micro porous layer; gas diffusion layers that are disposed on the both surfaces of the micro current collecting layers; and separators that are disposed on both surfaces of the gas diffusion layer.

A method for manufacturing a fuel cell according to a third preferred embodiment of the present invention includes: preparing a first laminate for an electrode by sequentially disposing a first gas diffusion layer, a first micro current collecting layer, a first micro porous layer, and a first catalyst layer on a first separator and forming a first electrolyte layer by applying an electrolyte solution on the first catalyst layer; preparing a second laminate for an electrode by sequentially disposing a second gas diffusion layer, a second micro current collecting layer, a second micro porous layer, and a second catalyst layer on a second separator and forming a second electrolyte layer by applying an electrolyte solution on the second catalyst layer; and surface-contacting the first laminate for the electrode and the second laminate for the electrode so that the first electrolyte layer of the first laminate for the electrode contacts the second electrolyte layer for the second laminate for the electrode with each other.

The first and second micro current collecting layers may be each impregnated in the first and second micro porous layers.

Preferably, the first laminate for the electrode and the second laminate for the electrode surface-contact with each other in a non-dried state, i.e., wet state.

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

### BRIEF DESCRIPTION OF THE DRAWINGS

FIG. 1 is a cross-sectional view for schematically explaining a membrane-electrode assembly for a fuel cell according to a preferred embodiment of the present invention;

FIG. 2 is a cross-sectional view for schematically explaining a structure of a fuel cell according to a preferred embodiment of the present invention;

FIGS. 3 to 10 are process flow charts for schematically explaining a method for manufacturing a fuel cell according to a preferred embodiment of the present invention;

FIG. 11 is a graph comparing polaration curve performances of fuel cells according to Example 1 of the present invention and Comparative Example 1;

FIG. 12 is a graph comparing impedance performances of fuel cells at 0.7V according to Example 1 of the present invention and Comparative Example 1; and

FIG. 13 is a graph comparing impedance performances of fuel cells at 0.5V according to Example 1 of the present invention and Comparative Example 1.

### DESCRIPTION OF THE PREFERRED EMBODIMENTS

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted. In the description, the terms “first,” “second,” and so on are used to distinguish one element from another element, and the elements are not defined by the above terms.

Hereinafter, preferred embodiments of the present invention will be described in detail with reference to the accompanying drawings.

Membrane-Electrode Assembly for Fuel Cell and Fuel Cell

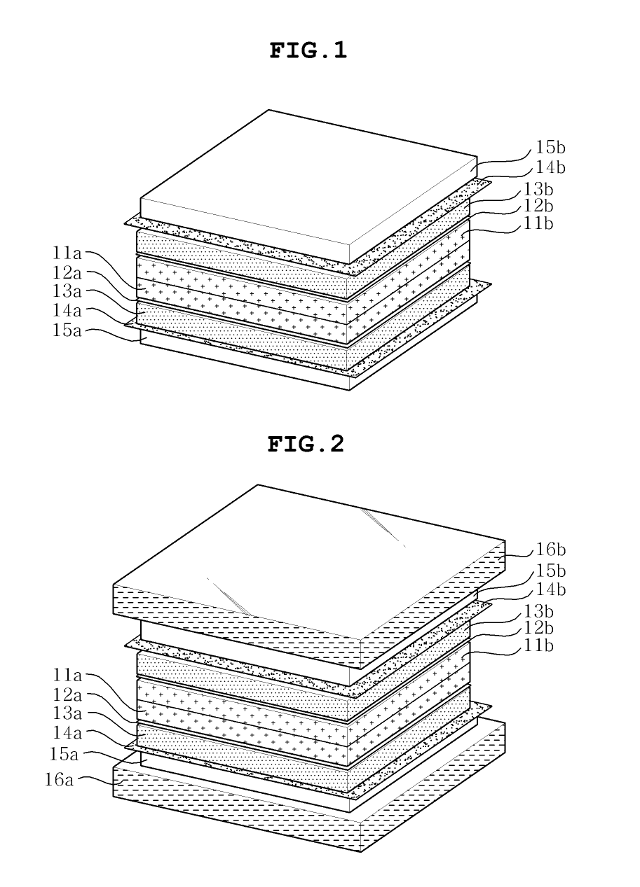

FIGS. 1 and 2 are each cross-sectional views for schematically explaining a structure of a membrane-electrode assembly for a fuel cell and a fuel cell according to a preferred embodiment of the present invention.

Referring to FIG. 1, a membrane-electrode assembly for a fuel cell according to a preferred embodiment of the present invention includes electrolyte layers 11a and 11b that are formed by surface-contacting two electrolyte solutions with each other, catalyst layers 12a and 12b that are disposed on both sides of the electrolyte layers 11a and 11b, micro porous layers 13a and 13b that are disposed on both sides of the catalyst layers 12a and 12b, micro current collecting layers 14a and 14b that are disposed on both sides of the micro porous layers 13a and 13b, and gas diffusion layers 15a and 15b that are disposed on both sides of the micro current collecting layers 14a and 14b.

Referring to FIG. 2, a fuel cell according to a preferred embodiment of the present invention includes the membrane-electrode assembly having a structure shown in FIG. 1 and separators 16a and 16b that are disposed on both sides of the membrane-electrode assembly.

The electrolyte layers 11a and 11b are formed by surface-contacting the two electrolyte solutions, thereby minimizing the resistance of the contact surface between the interfaces and closely contacting between the interfaces. As the electrolyte solution, liquid or sol in which a solid electrolyte is dispersed or liquid in which a solid electrolyte is dissolved can be used.

The solid electrolyte may generally include a proton conductive polymer such as fluorinated solid polymer electrolyte, hydrocarbon-based solid polymer electrolyte, or the like, that are used as material of an electrolyte layer for a fuel cell. For example, the solid electrolyte may include one or more proton conductive polymer selected from perfluoro-based polymer, Benzimidazole-based polymer, polyimide-based polymer, polyetherimide-based polymer, polyphenylenesulfide-based polymer, polysulfone-based polymer, polyethersulfone-based polymer, polyetherketone-based polymer, polyether-etherketone base polymer, and polyquinoxaline-based polymer, in more detail, one or more proton conductive polymer selected from poly (perfluorosulfonic acid), poly (perfluorocarboxylic acid), copolymer of tetrafluoroethylene and fluorovinylether including sulfonic acid group, defluorinated sulfide poly etherketone, arylketone, poly (2,2′-(m-phenylene)-5.5′-bibenzimidazole), and poly (2,5-benzimidazole) However, the solid electrolyte used for the fuel cell of the present invention is not limited thereto, Further, a kind of solvents according to a kind of the actually used polymer electrolytes is not specifically limited and therefore, can be optionally selected.

One side of the catalyst layers 12a and 12b are formed of a catalyst layer for a cathode and other sides thereof are formed of a catalyst layer for an anode. An example of the cathode (negative electrode) or the anode (positive electrode) catalyst materials may include one or more catalyst selected from a group consisting of platinum, ruthenium, osmium, platinum-ruthenium alloy, platinum-osmium alloy, platinum-palladium alloy, and platinum-M alloy (M=one or more transition metal selected from a group consisting of Ga, Ti, V, Cr, Mn, Fe, Co, Ni, Cu, and Zn), but is not limited thereto.

The micro porous layers 13a and 13b, which assist the diffusion of hydrogen gas and oxygen gas, may be formed of a carbon layer on which micro pores having several μm or less are formed. For example, the micro porous layers may include one or more selected from a group consisting of graphite, carbon nanotube (CNT), fullerene (C60), activated carbon, and carbon black.

The fine current collecting layers 14a and 14b shortens the moving distance of electrons, thereby serving to reduce resistance. In the prior art, current is collected in a direction of catalyst layer->micro porous layer->gas diffusion layer->separator, which results in increasing the moving distance of electrons to make the effect of the resistance large. As a result, the electric resistance of the gas diffusion layer itself and the contact resistance at the contacting surface on both sides are increased, thereby largely increasing the loss at the time of collecting current. On the other hand, in the present invention, the current collecting layer is disposed on just the catalyst layer, not the end of the separator, together with the micro porous layer, such that electrons having low power loss directly move to the micro current collecting layer, thereby making it possible to reduce the entire power loss.

Preferably, the micro current collecting layer minimizes the resistance at the time of collecting current, thereby making it possible to minimize the performance loss. To this end, the micro current collecting layer may be made of high conductive metal materials such as gold (Au), silver (Ag), copper (Cu), aluminum (Al), iron (Fe), an alloy thereof, or a combination thereof.

The micro current collecting layer may preferably have a mesh structure so as to facilitate the gas permeability and diffusion to the micro porous layer and the catalyst layer from the gas diffusion layer and maintain the high performance. More preferably, the micro current collecting layer may have the mesh structure of 10-1000 mesh numbers but is not limited thereto.

The micro current collecting layer preferably has a thin thickness of several μm to several tens of μm to show an effect obtained by impregnating the micro current collecting layer into the micro porous layer by including the sufficient thickness or most thickness of the micro current collecting layer when the micro porous layer is coated on the micro current collecting layer. In this case, electrons generated from the catalyst layer are directly transferred to the micro current collecting layer contacting the micro porous layer with a short moving distance, thereby making it possible to minimize the current collecting resistance and loss.

The gas diffusion layers 15a and 15b smoothly supply hydrogen gas and oxygen gas supplied from the outside to the catalyst layer to assist the formation of the triple-phase interface of the catalyst-electrolyte membrane-gas. As the gas diffusion layers 15a and 15b, a carbon paper or a carbon cloth may be used.

Generally, the separators 16a and 16b are provided with a passage that is coupled with the outside of the gas diffusion layers 15a and 15b of the membrane-electrode assembly to supply fuel and discharge water generated by the reaction.

In the above-mentioned fuel cell of the present invention, the gas diffusion layer, the micro current collecting layer, the micro porous layer, the catalyst layer, and the electrolyte layer closely contact with each other without creating gaps, thereby making it possible to minimize the resistance between each interface and improve the performance thereof

In the anode of the unit cell configured as described above, protons and electrons are generated by performing the oxidation reaction of hydrogen using water. In this case, the generated protons and electrons each move to the cathode opposite to the anode through the electrolyte layer and the conductor. At the same time, the cathode performs the reduction reaction of oxygen by receiving the protons and electrons generated from the anode, thereby generating water. At this time, electric energy is generated by the flow of electrons that flows along the conductor.

Method for Manufacturing Fuel Cell

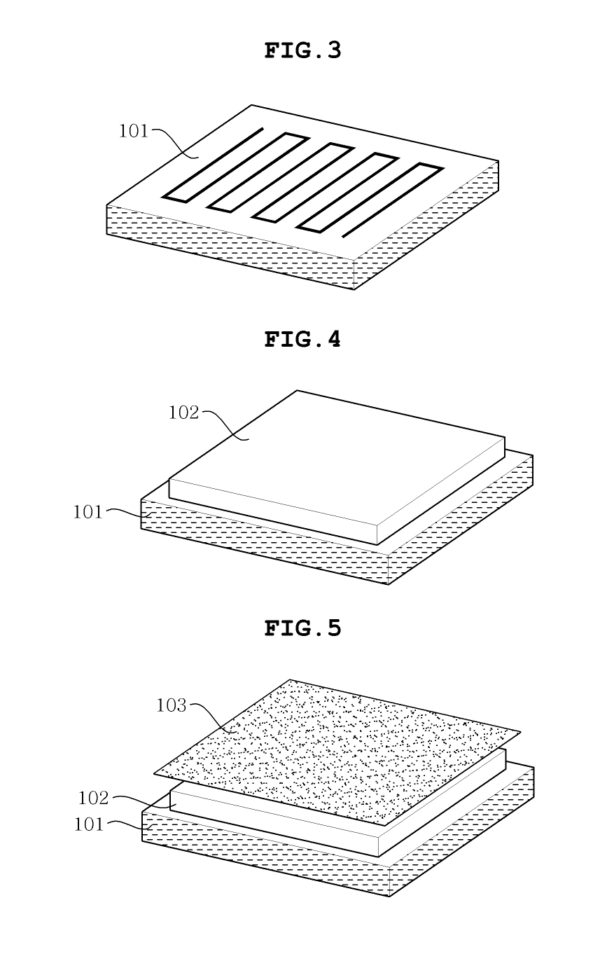

FIGS. 3 to 10 are process flow charts for schematically explaining a method for manufacturing a fuel cell according to a preferred embodiment of the present invention.

First, referring to FIGS. 3 and 4, a first gas diffusion layer 102 is first disposed on a first separator 101.

Generally, the separator 101 is provided with a passage that is coupled with the outside of the gas diffusion layer 102 to supply fuel and discharge water generated by the reaction.

The gas diffusion layers 102 smoothly supplies hydrogen gas and oxygen gas supplied from the outside to the catalyst layer to assist the formation of the triple-phase interface of the catalyst-electrolyte membrane-gas. As the gas diffusion layers 102, a carbon paper or a carbon cloth may be used.

Next, as shown in FIG. 5, the first micro current collecting layer 103 is disposed on the first gas diffusion layer 102.

The micro current collecting layer 103 directly transfers electrons generated from the catalyst layer to the micro current collecting layer contacting the micro porous layer with the short moving distance, thereby making it possible to minimize the current collecting resistance and loss.

The micro current collecting layer preferably has a mesh structure and may be made of the high conductive metal materials such as gold (Au), silver (Ag), copper (Cu), aluminum (Al), iron (Fe), an alloy thereof, or a combination thereof. In addition, at the following step, the micro current collecting layer preferably has a thin thickness of several μm to several tens of μm which shows an effect obtained by impregnating the micro current collecting layer into the micro porous layer that includes the sufficient thickness or most of the thickness of the micro current collecting layer when the micro porous layer is coated on the micro current collecting layer.

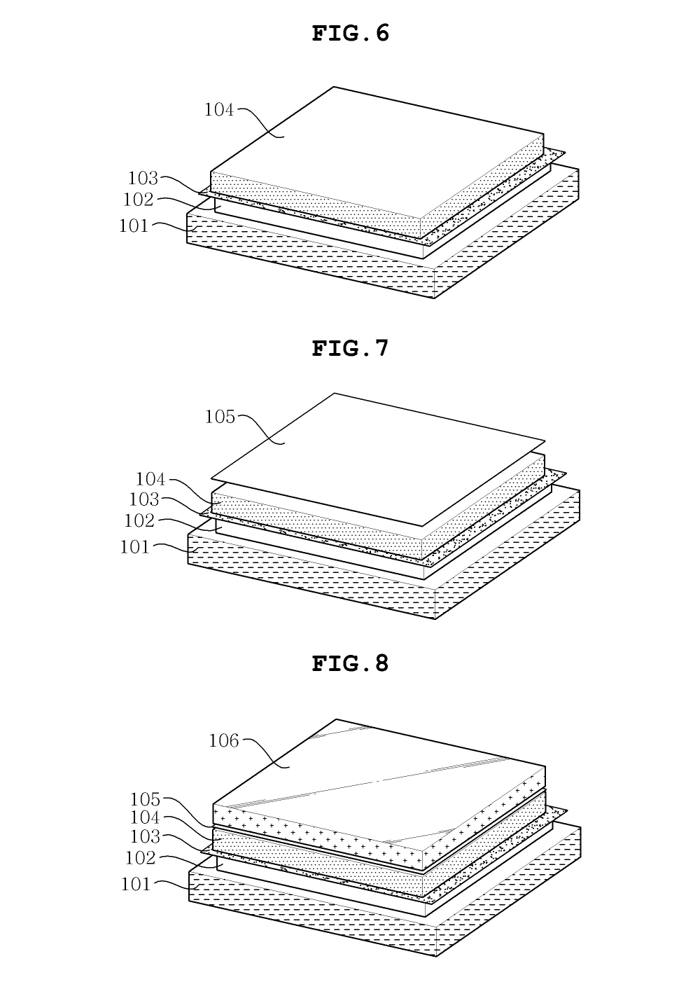

Next, as shown in FIG. 6, the first micro porous layer 104 is disposed on the first micro current collecting layer 103.

The micro porous layer 104 is to help the diffusion of hydrogen gas and oxygen gas. Preferably, the micro porous layer 104 is formed of a carbon layer on which the micro pores having several μm or less is formed. For example, the micro porous layer 104 may include one or more selected from a group consisting of graphite, carbon nanotube (CNT), fullerene (C60), activated carbon, and carbon black.

In this case, the micro current collecting layer may be impregnated in the micro porous layer.

Next, as shown in FIG. 7, the first catalyst layer 105 is disposed on the first micro porous layer 104.

The catalyst layer 105 may be formed by preparing a catalyst ink by dispersing, for example, the catalyst materials for the anode or the catalyst materials for the cathode in the organic solvent and then, depositing and coating it. In this case, the catalyst layer may be formed by using a general deposition method. Preferably, the deposition method selected from a sputtering method, a thermal chemical vapor deposition method (Thermal CVD), a plasma enhanced chemical deposition method (PECVD), a thermal evaporation method, an electrochemical deposition method, and an e-beam evaporation method can be used. However, the deposition method is not limited to the methods. If necessary, a combination of two or more of the methods can be used.

The catalyst layer preferably includes one or more catalyst selected from a group consisting of platinum, ruthenium, osmium, platinum-ruthenium alloy, platinum-osmium alloy, platinum-palladium alloy, and platinum-M alloy (M=one or more transition metal selected from a group consisting of Ga, Ti, V, Cr, Mn, Fe, Co, Ni, Cu, and Zn), more preferably, includes platinum, ruthenium, osmium, platinum-ruthenium alloy, platinum-osmium alloy, platinum-palladium alloy, platinum-cobalt alloy, and platinum-nickel, but is not specifically limited thereto.

Next, as shown in FIG. 8, a first laminate for an electrode is prepared by forming an electrolyte layer 106 on the first catalyst layer 105 by applying an electrolyte solution.

As the electrolyte solution, a liquid or a sol in which the solid electrolyte is dispersed or a liquid in which the solid electrolyte is dissolved.

As the solid electrolyte, proton conductive polymer, such as fluorinated solid polymer electrolyte and hydrocarbon-based solid polymer electrolyte that are used as the electrolyte membrane for the fuel cell is generally included. However, the polymer electrolyte used to manufacture the fuel cell of the present invention is known to those skilled in the art and is not specifically limited. Further, a solvent is not specifically limited according to a kind of actually used solid electrolytes and may be appropriately selected.

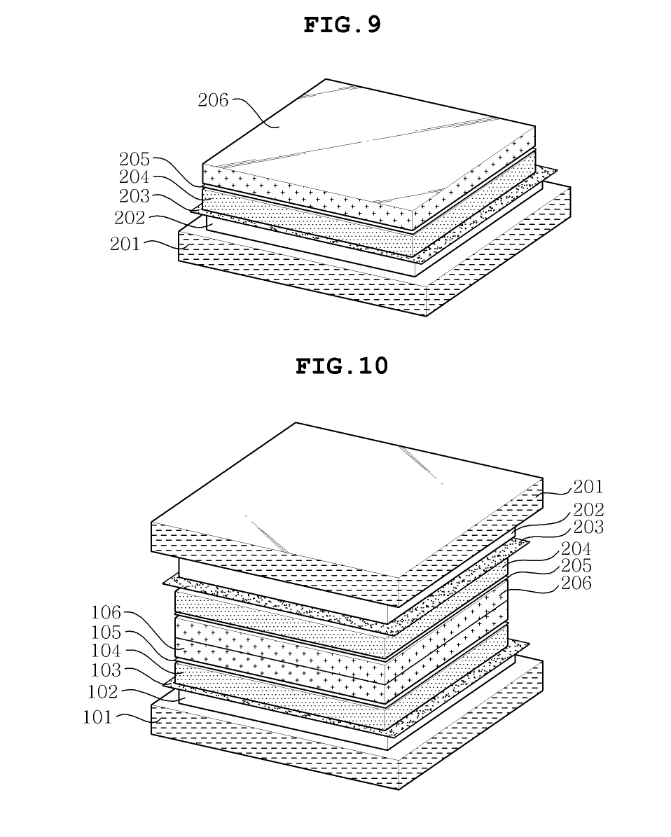

Next, as shown in FIG. 9, a second laminate for an electrode is prepared by sequentially disposing a second gas diffusion layer 202, a second micro current collecting layer 203, a second micro porous layer 204, and a second catalyst layer 205 on a second separator 201 and forming a second electrolyte layer 206 on the second catalyst layer 205 by applying an electrolyte solution thereon.

The configuration of each layer is already described in the process of preparing the first laminate for the electrode shown in FIGS. 3 to 8. However, when one of the first and second laminates for the electrode is prepared as the anode, it can be sufficiently appreciated to those skilled in the art that the other is prepared as the cathode.

Finally, as shown in FIG. 10, the fuel cell is manufactured by surface-contacting the first laminate for the electrode and the second laminate for the electrode, which are prepared as described above, so that the first electrolyte layer 106 of the first laminate for the electrode contacts the second electrolyte layer 206 of the second laminate for the electrode with each other.

In this case, it is preferable that the first laminate for the electrode and the second laminate for the electrode surface-contact with each other in a non-dried state, i.e., wet state.

The fuel cell manufactured as described above is directly operated in a unit cell, such that the interfaces of each layer can closely contact with each other without the separate hot pressing process.

As described above, the present invention surface-contacts the pair of laminates for the electrodes so that the electrolyte layers made of two electrolyte solutions contact with each other and directly connects them to the unit cell, thereby making it possible to minimize the contact surface resistance of the interface and closely contact each interface without the separate process of manufacturing the electrolyte membrane and the typical hot pressing process.

As described above, the existing methods uses the electrolyte membrane, such that they should use the high-temperature and high-pressure hot pressing process in order to reduce the interface resistance between the catalyst layer and the electrolyte membrane, but the method for manufacturing the fuel cell according to the present invention uses the electrolyte solution and directly applies it, such that it does not require the hot pressing process.

Further, the present invention does not require the electrolyte membrane pre-treating process, such that it can correspondingly reduce the treating time and cost and reduce the material costs and the mechanical facility costs for producing the electrolyte membrane.

Further, according to the present invention, the membrane-electrode assembly for the fuel cell can be manufactured by the continuous one-time process, which is more efficient in the cost reduction and the mass production.

The method for manufacturing the fuel cell according to the present invention can be applied to all the fuel cell type based on the proton exchange membrane fuel cells. That is, the manufacturing method can be applied to manufacture the fuel cells and the stacks of all the kinds of fuel cell products based on the polymer electrolyte and can be also applied to a direct methanol fuel cell (DMFC).

Meanwhile, as the applicable products, the manufacturing method can be applied to a fuel cell for a small-sized mobile such as a fuel cell for a mobile phone, a notebook, or an MP3 as well as a large-sized fuel cell such as a fuel cell for an automobile.

Hereinafter, the present invention will be described in more detail with reference to the following examples and comparative examples, but is not limited thereto.

### Example 1

As shown in FIGS. 3 to 8, the first gas diffusion layer 102, the first micro current collecting layer 103, the first micro porous layer 104, and the first catalyst layer 105 (formed by the catalyst ink in which the catalyst material for the anode is dispersed) are sequentially formed on the first separator 101 and then, the electrolyte solution (for example, trade name “Nafion dispersion solution”) is applied to the first catalyst layer 105 to form the first electrolyte layer 106, thereby preparing the laminate for the first electrode (anode).

Next, as shown in FIG. 9, the second gas diffusion layer 202, the second micro current collecting layer 203, the second micro porous layer 204, and the second catalyst layer 205 (formed by the catalyst ink in which the catalyst material for the anode is dispersed) are sequentially formed on the second separator 201 and then, the electrolyte solution (for example, trade name Nafion dispersion solution) is applied to the second catalyst layer 205 to form the second electrolyte layer 206, thereby preparing the laminate for the second electrode (cathode).

Next, as shown in FIG. 10, the laminate for the first electrode (anode) surface-contacts the second laminate for the second electrode (cathode) so that the first electrolyte layer 106 and the second electrolyte layer 206 contact each other, thereby manufacturing the fuel cell.

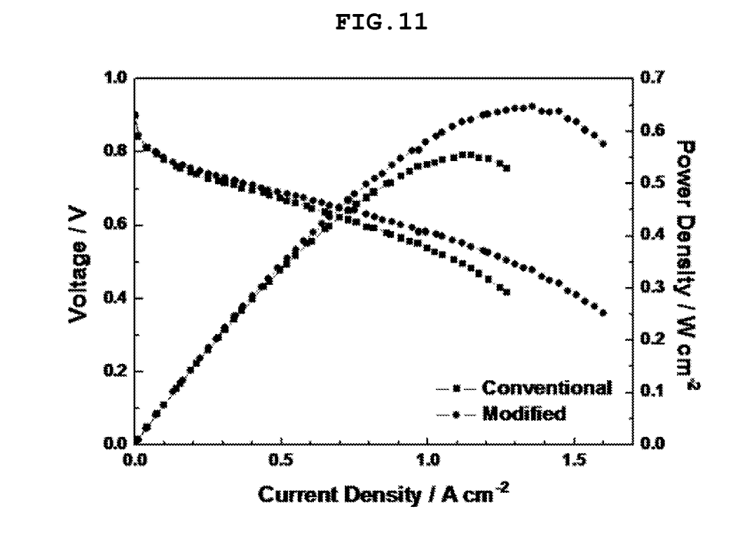

The fuel cell manufactured as described above is operated by being directly connected to the unit cell. Through the operation, the polarization curve performance and the impedance (0.7V, 0.5V) performance are each measured. FIGS. 11 to 13 showed the measured results.

### Comparative Example 1

The catalyst layer is formed on both surfaces by using poly (perfluorosulfonic acid) layer (trade name “Nafion 112”) as the polymer electrolyte membrane and the two sheets of gas diffusion layers on which the micro porous layer is coated are formed on both surface of the catalyst layer and are subjected to the hot pressing process, thereby manufacturing the membrane-electrode assembly. The separator is disposed on both surfaces of the membrane-electrode assembly manufactured as described above, thereby manufacturing the fuel cell.

The fuel cell manufactured as described above is operated by being directly connected to the unit cell. Through the operation, the polar curve performance and the impedance (operating voltage 0.7V and 0.5V) performance are each measured under the H₂/air supplying condition. FIGS. 11 to 13 showed the measured results.

FIGS. 11 to 13 are graphs comparing the polarization curve performance, the impedance performance at operating voltage 0.7V, and the impedance performance at operating voltage 0.5V of the fuel cell according to Embodiment 1 and Comparative example 1 of the present invention.

FIG. 11 showed that the fuel cell (Example 1: Modified) according to the present invention has higher power density than the fuel cell using the existing technology (Comparative 1: Conventional) in the polarization curve of the hydrogen and air supplying condition.

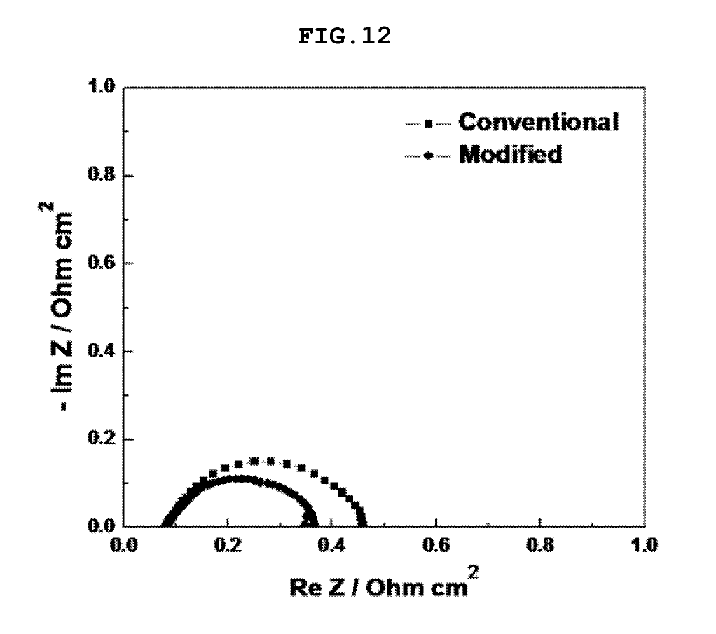

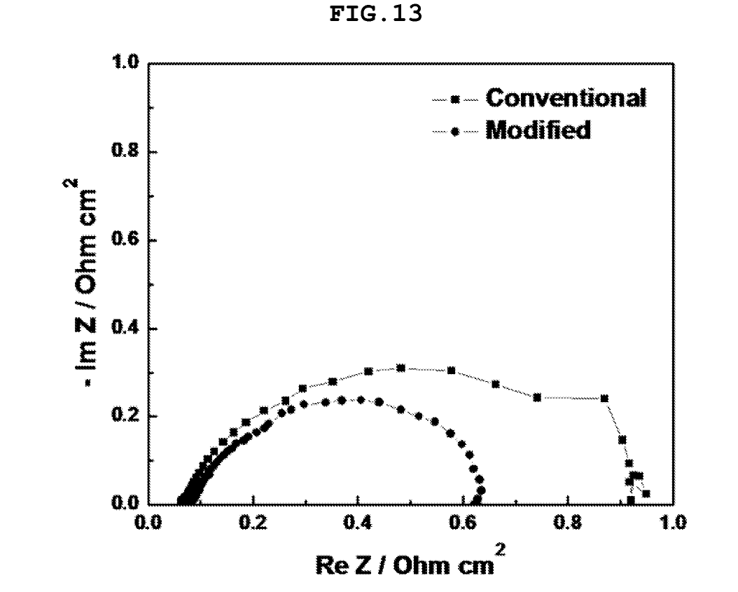

Further, as shown in FIGS. 12 and 13, it could be appreciated from the impedance analysis that the fuel cell (Example 1: Modified) according to the present invention has a lower resistance value than the fuel cell using the existing technology (Comparative example 1: Conventional) under the same voltage condition.

According to the membrane-electrode assembly for the fuel cell and the fuel cell of the present invention, the gas diffusion layer, the micro current collecting layer, the micro porous layer, the catalyst layer, and the electrolyte layer can be formed at a time without creating gaps, thereby making it possible to minimize the resistance between each interface and improve the performance thereof.

In addition, the known method uses the high-temperature and high-pressure hot pressing process in order to reduce the interface resistance between the catalyst layer and the electrolyte membrane due to the use of the electrolyte membrane, but the present invention directly applies the electrolyte solution, thereby making it possible to omit the hot pressing process nor needing to perform the electrolyte membrane pre-treating process, thereby making it possible to reduce the treating time and costs and reduce the material costs for producing the electrolyte membrane and the mechanical facility costs. Further, the membrane-electrode assembly for the fuel cell can be manufactured by a continuous one-time process, which is more efficient in the cost reduction and the mass production

Although the preferred embodiments of the present invention have been disclosed for illustrative purposes, they are for specifically explaining the present invention and thus a membrane-electrode assembly for a fuel cell, a fuel cell, and a manufacturing method thereof according to the present invention are not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A membrane-electrode assembly for a fuel cell, comprising:
an electrolyte layer formed by surface-contacting two electrolyte solutions with each other;
catalyst layers that are disposed on both surfaces of the electrolyte layer;
micro porous layers that are disposed on both surfaces of the catalyst layer;
micro current collecting layers that are disposed on both surfaces of the micro porous layer; and
gas diffusion layers that are disposed on the both surfaces of the micro current collecting layers.

2. The membrane-electrode assembly for a fuel cell as set forth in claim 1, wherein the micro current collecting layer is made of Au, Ag, Cu, Al, Fe, an alloy thereof, or a combination thereof.

3. The membrane-electrode assembly for a fuel cell as set forth in claim 1, wherein the micro current collecting layer has a mesh structure.

4. The membrane-electrode assembly for a fuel cell as set forth in claim 1, wherein the micro current collecting layer is set to have a thickness of several μm to several tens of μm.

5. The membrane-electrode assembly for a fuel cell as set forth in claim 1, wherein the micro current collecting layer is impregnated in the micro porous layer.

6. A fuel cell, comprising:
an electrolyte layer formed by surface-contacting two electrolyte solutions each other;
catalyst layers that are disposed on both surfaces of the electrolyte layer;
micro porous layers that are disposed on both surfaces of the catalyst layer;
micro current collecting layers that are disposed on both surfaces of the micro porous layer;
gas diffusion layers that are disposed on the both surfaces of the micro current collecting layers; and
separators that are disposed on both surfaces of the gas diffusion layer.

7. The fuel cell as set forth in claim 6, wherein the micro current collecting layers is made of Au, Ag, Cu, Al, Fe, an alloy thereof, or a combination thereof.

8. The fuel cell as set forth in claim 6, wherein the micro current collecting layer has a mesh structure.

9. The fuel cell as set forth in claim 6, wherein the micro current collecting layer is set to have a thickness of several μm to several tens of μm.

10. The fuel cell as set forth in claim 6, wherein the micro current collecting layer is impregnated in the micro porous layer.

11. A method for manufacturing a fuel cell, comprising:
preparing a first laminate for an electrode by sequentially disposing a first gas diffusion layer, a first micro current collecting layer, a first micro porous layer, and a first catalyst layer on a first separator and forming a first electrolyte layer by applying an electrolyte solution on the first catalyst layer;
preparing a second laminate for an electrode by sequentially disposing a second gas diffusion layer, a second micro current collecting layer, a second micro porous layer, and a second catalyst layer on a second separator and forming a second electrolyte layer by applying an electrolyte solution on the second catalyst layer; and
surface-contacting the first laminate for the electrode and the second laminate for the electrode so that the first electrolyte layer of the first laminate for the electrode contacts the second electrolyte layer for the second laminate for the electrode each other.

12. The method for manufacturing a fuel cell as set forth in claim 11, wherein each of the first and second micro current collecting layer is made of Au, Ag, Cu, Al, Fe, an alloy thereof, or a combination thereof.

13. The method for manufacturing a fuel cell as set forth in claim 11, wherein each of the first and second micro current collecting layers has a mesh structure.

14. The method for manufacturing a fuel cell as set forth in claim 11, wherein each of the first and second micro current collecting layers is set to have a thickness of several μm to several tens of μm.

15. The method for manufacturing a fuel cell as set forth in claim 11, wherein the first micro current collecting layer is impregnated in the first micro porous layer.

16. The method for manufacturing a fuel cell as set forth in claim 11, wherein the second micro current collecting layer is impregnated in the second micro porous layer.

17. The method for manufacturing a fuel cell as set forth in claim 11, wherein the first laminate for the electrode and the second laminate for the electrode surface-contact with each other in a non-dried state.
